(19) United States
(12) Patent Application Publication
(10) Pub. No.: US 2007/0113396 A1
(43) Pub. Date: May 24, 2007

(54) APPARATUS FOR APPLYING A VENEER TO SHAPED BATTENS

(76) Inventor: Mauro ORSI, Firenze (IT)

Correspondence Address: MCGLEW & TUTTLE, PC, P.O. BOX 9227, SCARBOROUGH STATION, SCARBOROUGH, NY, 10510-9227, US

(21) Appl. No.: 11/423,991

(22) Filed: Jun. 14, 2006

(30) Foreign Application Priority Data
Nov. 24, 2005 (IT) FI2005A000243

(51) Int. Cl. B23P 19/04

(52) U.S. Cl. 29/728

(57) ABSTRACT

To apply veneer to battens with variable cross-sections, the apparatus—provided with pressure wheels operating on undulated longitudinal areas of the surfaces to be veneered—has each pressure wheel mounted on its own support which stresses it elastically against the surface to be veneered; successive wheels operating on the same longitudinal area are spaced from one another by distances corresponding to a plurality of longitudinal undulations.

The present invention refers to an apparatus used to apply a veneer to shaped battens, which comprises pressure wheels operating on longitudinal areas of the surface to be covered with a bonded veneer.

This type of apparatus is currently produced to apply veneer to battens with uniform cross-sections.

The invention relates to an apparatus which is suitable also to veneer battens with cross-sections that vary from area to area.

To overcome the problems arising in the aforesaid cases, according to the invention each pressure wheel is mounted on its own support produced to elastically stress it against the surface to be veneered; moreover, successive wheels operating on the same longitudinal area are spaced from one another by distances corresponding to several longitudinal undulations (at least two or preferably at least three undulations).

In an apparatus which comprises several contiguous longitudinal areas on which respective pressure wheels operate, advantageously the wheels operating on a longitudinal area are staggered with respect to the wheels operating on contiguous longitudinal areas. In practice, wheels operating on several contiguous longitudinal areas can be staggered with a symmetrical arrangement with respect to an intermediate longitudinal area.

To obtain the above, a support for a single pressure wheel can be produced to have an elastically flexible linear component, or to have an elastically yielding joint, or yet again to have a component produced in a telescoping section cooperating with axial compression spring.

In any case, it is guaranteed that the actions of the wheels cause application of the veneer quickly and completely with a relatively very high productivity and without breakage of the layer of superior wood used to form the veneer.

The finding will be better understood by following the description and accompanying drawing, which shows a non-limiting practical embodiment of said finding. In the drawing:

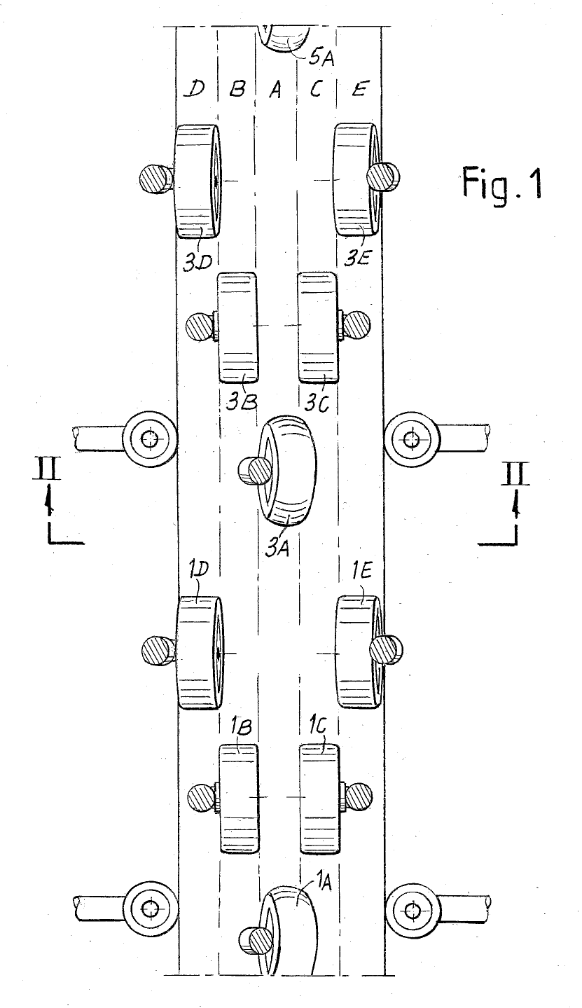

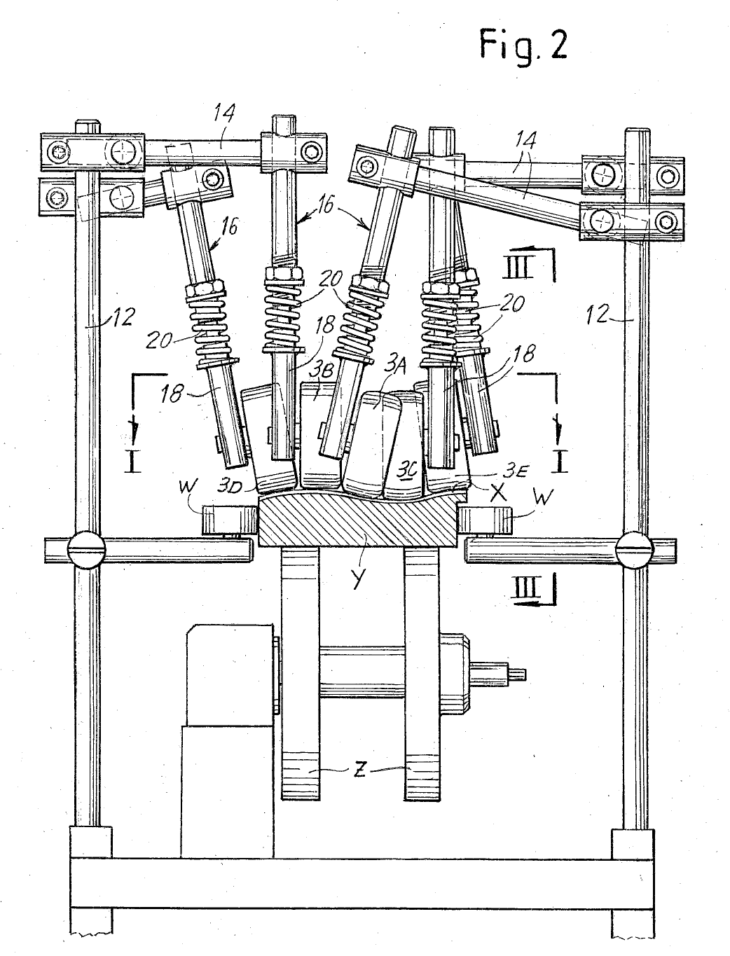

FIG. 1 is a plan view according to I-I of FIG. 2;

FIG. 2 is a cross section according to II-II of FIG. 1;

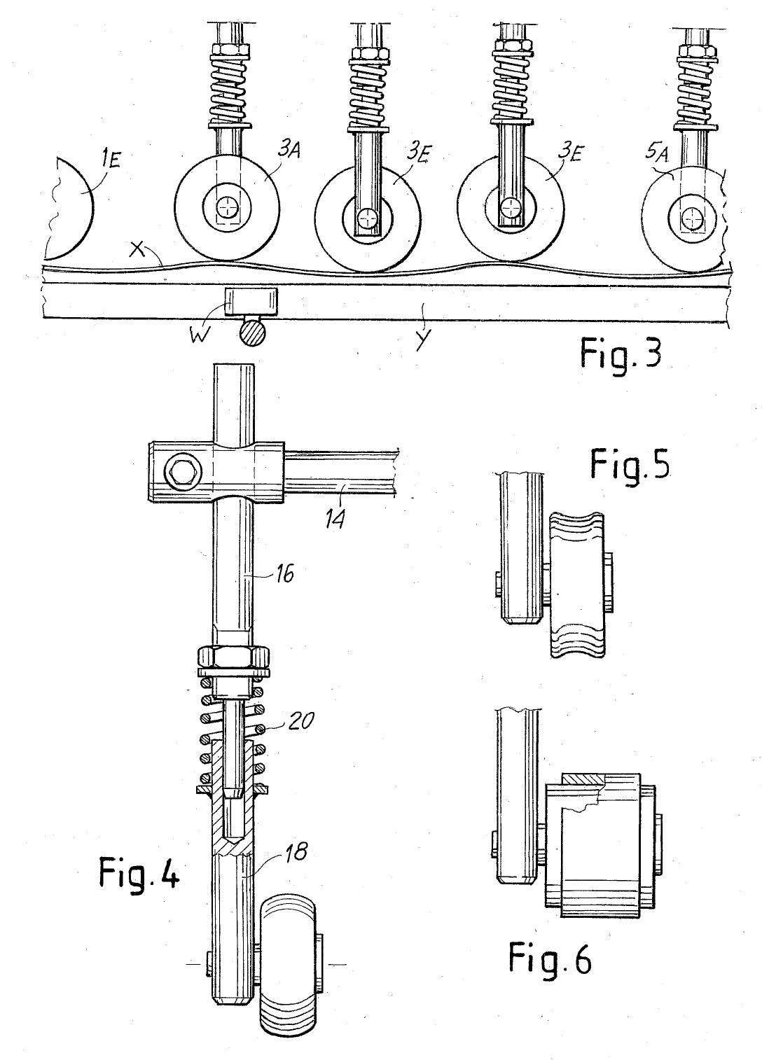

FIG. 3 is a view of the line III-III in FIG. 2;

FIG. 4 shows an enlarged and partly sectional detail of FIG. 1;

FIGS. 5 and 6 show two further embodiments of the wheels.

According to the illustration in the accompanying schematic and summary drawing, Y indicates a batten of inferior wood, which is to be covered with a veneer X, composed of a thin layer of superior wood, to be bonded to the front face of the batten Y. Feed means of the battens Y are indicated with Z and wheels to guide the battens with W.

Veneer is currently applied—with continuously operating apparatus—only to battens with a constant cross-section.

According to the invention it is instead possible to apply veneer Y to battens X with a longitudinal section that is not constant, as can be seen in particular in FIG. 3. In these cases current apparatus with wheels in close reciprocal positions do not guarantee secure bonding of the veneer or integrity of the thin layer of superior wood, which can split during the veneering operation with known apparatus; moreover, it is not possible to operate in conditions of productivity that are sufficiently high or have relatively long times, as the glues to be used must be quick setting to avoid jeopardizing bonding of the veneer.

According to the invention and to the drawing (FIG. 1), pressing wheels, such as the ones 1A-1B-1C-1D-1E, the ones 3A-3B-3C-3D-3E, the one 5A and others are provided, operating on adjacent longitudinal areas A, B, C, D, E and other areas of the surface to be veneered; the wheels operating on their respective longitudinal area are spaced apart by distances comprising at least two, three or more successive undulations or fractions of successive undulations of the respective longitudinal area.

Advantageously the wheels operating on contiguous longitudinal areas are also staggered from one another, as can be seen in particular in FIG. 1.

Moreover, according to the invention each wheel is mounted on its own support (indicated with 12 to 20), with each support having an elastic deformability of its own. Therefore, each wheel is susceptible to press—on the veneer to be bonded—independently from the others of its own longitudinal area and of the contiguous longitudinal areas, in order to guarantee its bonding function in the presence of transverse and longitudinal undulations. In the drawing, an upright 12, a cross-member 14 that can engage with the upright 12, a downward facing section 16 and an end 18 on which a respective wheel is mounted are indicated for each wheel support; the various components can be engaged in various angles (also elastically yielding) while the two components 16 and 18 slide and are stressed by springs 20 symbolizing the elastic pressure capacity that can be exerted by the wheels against the surface to be bonded.

In any case, the supports 12 to 18 are adjustable in position to press the respective wheel against the pertinent longitudinal area, such as the ones A, B, C, D, E.

By suitable adjusting the distance between contiguous wheels along the longitudinal areas such as the ones A, B, C, D, E, and between wheels operating on contiguous longitudinal areas, and adjusting the speed at which the battens pass through the apparatus in question, efficient bonding is obtained without the risk of the veneer to be applied splitting or disintegrating and without the risk of bonding being jeopardized by the quick setting glue.

The veneered surface can subsequently be treated by varnishing uniformly, with subsequent brushing operations performed to obtain attenuations of the varnish and/or other suitable effects.

The longitudinal frequency of the undulations can correspond in all the areas such as the ones A, B, C, D but can also differ in the various longitudinal areas; in each longitudinal area it is advisable for successive wheels to operate at a distance of at least two or preferably three depressions, or fractions thereof, and preferably on a projection and on a depression spaced apart.

FIGS. 5 and 6 show further embodiments of pressure wheels operating on the veneer.

It is understood that the drawing only shows an example provided by way of a practical demonstration of the finding, which may vary in forms and arrangements without however departing from the scope of the concept on which the finding is based.

What I claim is:

1. Apparatus for applying a veneer to shaped battens with variable cross-sections, said apparatus comprising pressure wheels operating on undulated longitudinal areas of the surfaces to be covered with a bonded veneer, wherein each pressure wheel is mounted on its own support produced to elastically stress it against the surface to be veneered, and wherein successive wheels operating on the same longitudinal area are spaced from one another by distances corresponding to at least three or more longitudinal undulations.

2. Apparatus as claimed in claim 1, comprising a plurality of contiguous longitudinal areas on which respective pressure wheels operate, wherein wheels operating on a longitudinal area are staggered with respect to the wheels operating on contiguous longitudinal areas.

3. Apparatus as claimed in claim 2, wherein wheels operating on a plurality of contiguous areas are staggered with a symmetrical arrangement with respect to an intermediate longitudinal area.

4. Apparatus as claimed in claim 1, wherein a support for a single pressure wheel has an elastically flexible linear component.

5. Apparatus as claimed in claim 1, wherein a support for a single pressure wheel has an elastically yielding joint.

6. Apparatus as claimed in claim 1, wherein a support for a single pressure wheel has a component produced with a telescoping section cooperating with an axial compression spring.
